(19) United States
(12) Patent Application Publication
(10) Pub. No.: US 2017/0032471 A1
(43) Pub. Date: Feb. 2, 2017

(54) SOCIAL PROOFING FOR SUGGESTED PROFILE EDITS

(71) Applicant: LinkedIn Corporation, Mountain View, CA (US)

(72) Inventors: Befekadu Ayenew, San Leandro, CA (US); Ningfeng Liang, Cupertino, CA (US); Pratik Daga, Mountain View, CA (US); Gaganpreet Singh Shah, Union City, CA (US)

(21) Appl. No.: 14/964,484

(22) Filed: Dec. 9, 2015

Related U.S. Application Data
(60) Provisional application No. 62/199,200, filed on Jul. 30, 2015.

(51) Int. Cl. G06Q 50/00; H04L 29/08

(52) U.S. Cl. CPC G06Q 50/01; H04L 67/306

(57) ABSTRACT

A system, a machine-readable storage medium storing instructions, and a computer-implemented method are described herein are directed to a Social Proofing Engine (hereinafter “SP Engine”) that determines whether to update a target member account's profile with an attribute that is relevant to a resource accessed by the target member account. The SP Engine detects access by a target member account of a resource. The SP Engine identifies at least one trusted member account having a profile context attribute indicative of a type of affiliation with the resource. The SP Engine generates a prompt to update the target member account with the profile context attribute indicative of the type of affiliation with the resource.

### CROSS-REFERENCE TO RELATED APPLICATIONS

This application claims the benefit of priority to U.S. Provisional Patent Application entitled “Social Proofing,” Ser. No. 62/199,200, filed Jul. 30, 2015, which is hereby incorporated by reference herein in its entirety.

### TECHNICAL FIELD

The present disclosure generally relates to data processing systems. More specifically, the present disclosure relates to methods, systems and computer program products for updating profiles in a social network.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills; professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Social Proofing Engine, according to some embodiments.

FIG. 4 is a block diagram showing an example of identifying trusted member accounts with respect to a client device accessing a resource external to a professional social network service, according to some embodiments;

FIG. 5 is a block diagram showing an example prompt including a profile update functionality, according to some embodiments;

FIG. 6 is a flowchart illustrating a method of updating a target member account based on selection of a profile update functionality in a prompt; according to embodiments described herein.

FIG. 7 is a block diagram of an example computer system on which methodologies described herein may be executed, in accordance with an example embodiment.

### DETAILED DESCRIPTION

The present disclosure describes methods and systems for updating a target member account in a professional social networking service (also referred to herein as a “professional social network” or “social network”) based on a resource accessed by the target member account. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

A system, a machine-readable storage medium storing instructions, and a computer-implemented method are described herein are directed to a Social Proofing Engine (hereinafter “SP Engine”) that determines whether to update a target member account's profile with an attribute that is relevant to a resource accessed by the target member account. The SP Engine detects access by a target member account of a resource. The SP Engine identifies at least one trusted member account having a profile context attribute indicative of a type of affiliation with the resource. The SP Engine generates a prompt to update the target member account with the profile context attribute indicative of the type of affiliation with the resource.

According to various embodiments, the SP Engine detects a target member account in a professional social network service (hereinafter “social network” or “professional social network”) accessing a resource external to the social network. For example, the resource can be a website for an educational institution (“State University”). The SP Engine identifies trusted member accounts that have a respective profile that includes a profile context attribute that indicates an affiliation with the resource. In some embodiments, the SP Engine further identifies a trusted member account based on a type of degree of connection with the target member account. For example, the SP Engine identifies one or more trusted member accounts that have a 1^{st} degree social network connection and a profile attribute that indicates attendance at the State University. In another example, the SP Engine identifies one or more trusted member accounts based on a 1^{st} degree social network connection and a profile attribute that indicates attendance at the State University during a particular time range, such as years 1996-1998.

The SP Engine generates a prompt for display at a client device that corresponds with the target member account. The prompt includes a display of at least one of the identified trusted member accounts. The prompt further includes a profile update functionality. For example, the prompt may further include content based on the profile context attribute, such as “Are you a current or past student of State University?” In another example, the prompt may further include content based on the profile context attribute, such as “Did you attend State University between 1996-1998?”

When the SP Engine detects a selection of the profile update functionality by the target member account, the SP Engine initiates a session for the target member account in the social network. The SP Engine generates profile update content based on the profile context attribute(s) (i.e. State University, 1996-1998). The SP Engine updates the profile of the target member account with the profile update content. For example, the SP Engine updates the profile of the target member account with an attribute(s) that indicates attendance at the educational institution during the time range (i.e. “State University at 1996-1998”).

The SP Engine thereby leverages the type of resource being accessed by a target member and whether member accounts connected to the target member account have profile attributes related to the resource in order to gain insight into a likelihood of whether the target member account should also have a profile attribute related to the resource.

In various embodiments, the SP Engine is available within the professional social network or via various plug-ins on a client device that functions outside of a session in the professional social network. In alternative embodiments, social proofing data, with respect to a target member account(s), will be computed offline on a regular cadence and stored in databases in a data layer that will store lists of member account identifiers connected to the target member account according to a particular profile context attribute. As an example, a profile context attribute for a target member account's educational background can be: School, School+Degree, School+Field of Study, School+Start Year, School+End Year, or School+Degree+Field of Study.

If the SP Engine is identifying trusted accounts based on educational background, the SP Engine accesses a first database keyed by respective member account id's and a second database keyed by respective school ids. When the SP Engine detects that a target member account is accessing a resource for a particular education institution (such as a website for “State University”), the SP Engine checks the first and second databases for a list of member account identifiers keyed by that school (“State University”) for that target member account. Since the target member account may access different resources for different schools, the SP Engine creates different lists of member account identifiers (having a first degree connection with the target member account) keyed for each different school:

As an example, the SP Engine detects a target member account accessing the website for State University. Among the target member account's first degree connections is Member Account A, who has State University listed as a profile context attribute. The SP Engine searches the first and second databases, looking up State University under the member identifier of Member Account A. The SP Engine returns the member account identifiers of all member accounts—having a first degree connection with target member account—that have State University as a profile context attribute.

It is understood that the embodiments described herein are not limited to resources and profile context attributes related to educational institutions and employers. As an example, a resources and profile context attributes can be indicative of at least one of a skill, a group affiliation, a geographic location, a type of education degree or certification obtained, a job title, and a personal or professional interest. It is also further understood that the SP Engine resides on a client device, on a server device(s) or a module(s) of the SP Engine can execute on a client device in communication with a module(s) of the SP Engine running on a server device(s).

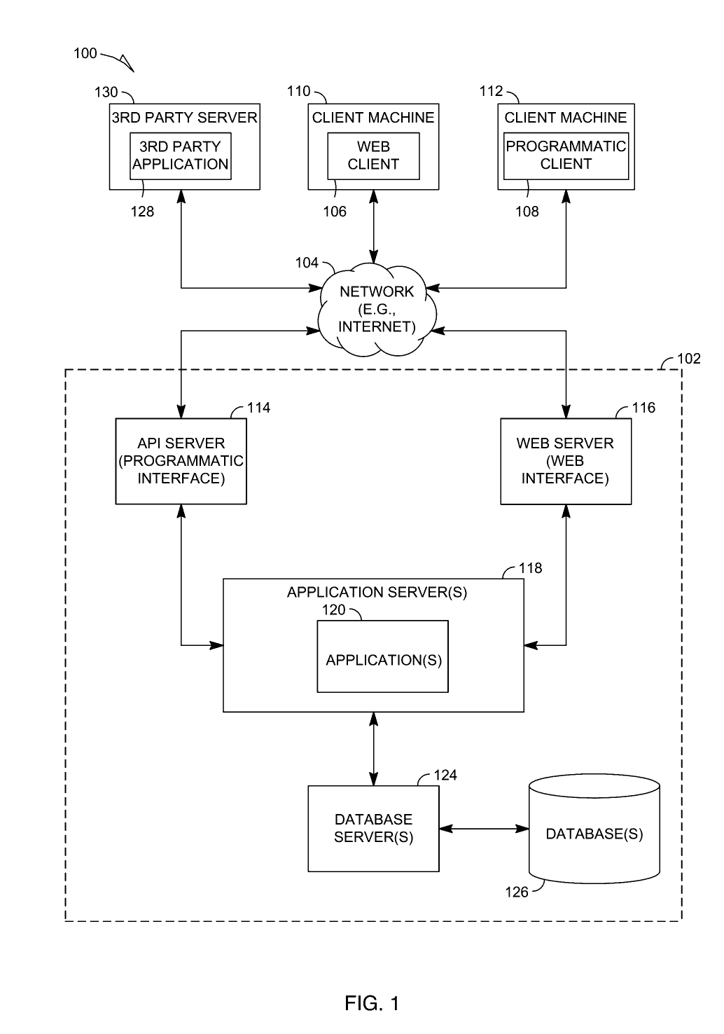

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

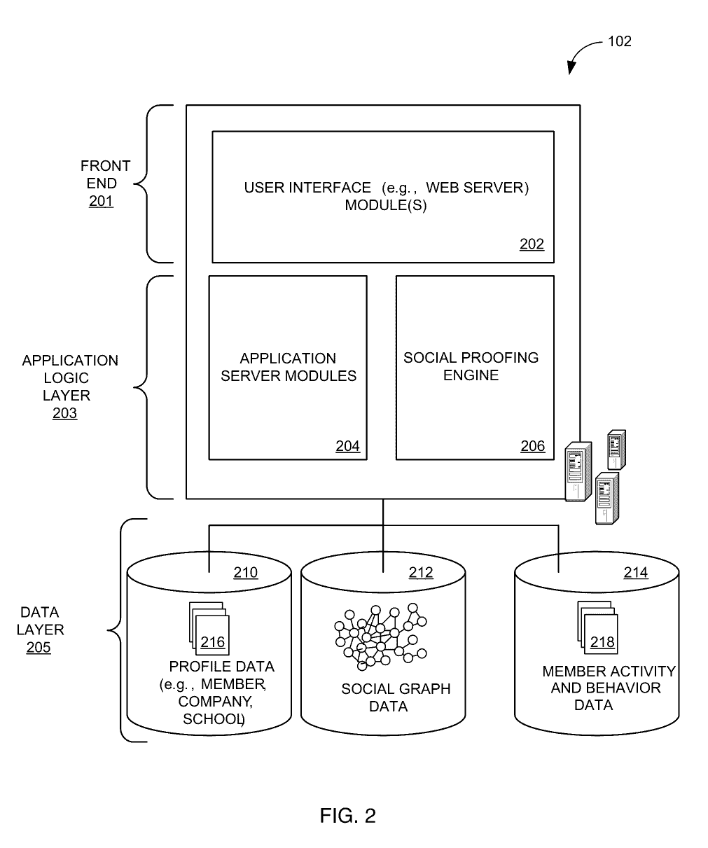

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a hi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour e.g., content viewed, links or member-interest buttons selected, etc.) may be monitored and information 218 concerning the member's activities and behaviour may be stored, for example, as indicated in FIG. 2, by the database 214. This information 218 may be used to classify the member as being in various categories and may be further considered as an attribute of the member. For example, if the member performs frequent searches of job listings, thereby exhibiting behaviour indicating that the member is a likely job seeker, this information 218 can be used to classify the member as being a job seeker. This classification can then be used as a member profile attribute for purposes of enabling others to target the member for receiving messages, status updates and/or a list of ranked premium and free job postings.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

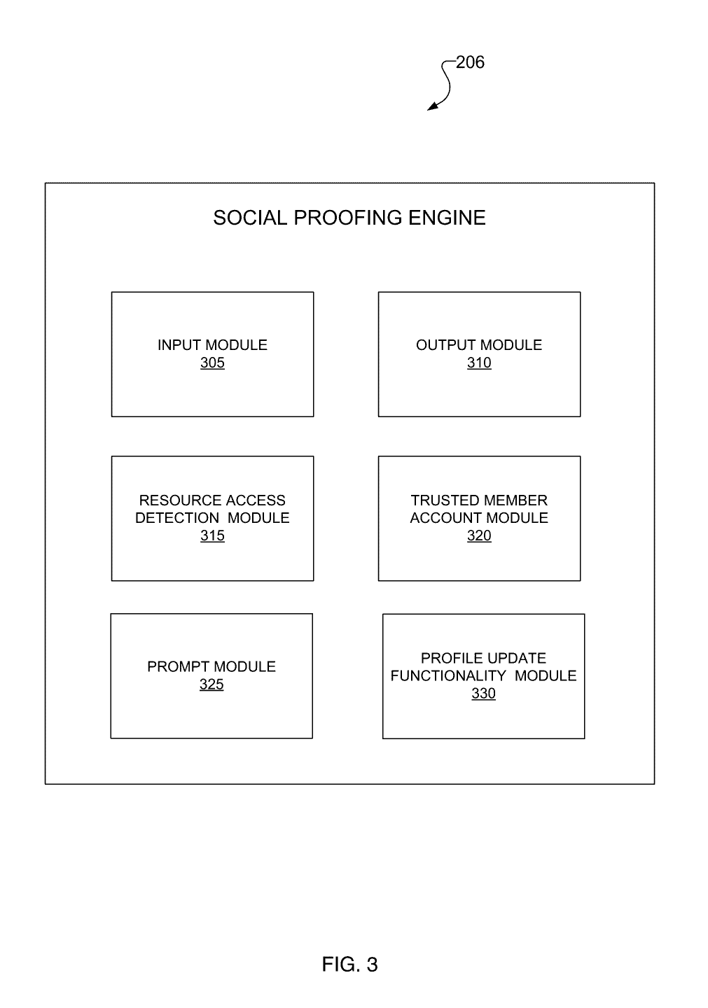

The data in the data layer 205 may be accessed, used, and adjusted by the SP Engine 206 as will be described in more detail below in conjunction with FIGS. 3-6. Although the SP Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

FIG. 3 is a block diagram showing example components of a Social Proofing Engine 206, according to some embodiments.

The input module 305 is a hardware-implemented module that controls, manages and stores information related to any inputs from one or more components of system 102 as illustrated in FIG. 1 and FIG. 2. In various embodiments, the inputs include a selection of a profile update functionality by a target member account. In various embodiments, an input also includes a selection of a profile attribute for a profile of any member account in the social network.

The output module 310 is a hardware-implemented module that controls, manages and stores information related to which sends any outputs to one or more components of system 100 of FIG. 1 (e.g., one or more client devices 110, 112, third party server 130, etc.). In some embodiments, the output is a prompt sent for a display on a client device that corresponds with a target member account.

The resource access detection module 315 is a hardware implemented module which manages, controls, stores, and accesses information related to detecting one or more target member accounts accessing a resource. In some embodiments, the predefined resource comprises a website external to the social network. In some embodiments, the resource comprises a location (or resource) within the social network.

The trusted member account module 320 is a hardware-implemented module which manages, controls, stores, and accesses information related to identifying one or more member accounts in the social network with profile context attributes that are indicative of a type of affiliation with the resource. In some embodiments, criteria for identifying a trusted member account includes validating an existence of a type of degree of connection with the target member account. In some embodiments, the trusted member account is not connected to the target member account, but may have one or more profile attributes which indicate that the particular member account is highly-affiliated with the resource currently accessed by the target member account. In some embodiments, such a highly-affiliated member account is a member account with a certain threshold amount of connections with other member accounts that each have a profile attribute related to the resource. In some embodiments, such a highly-affiliated member account is a member account with a certain threshold amount of endorsements from other member accounts that each have a profile attribute related to the resource. In some embodiments, such a highly-affiliated member account is a member account with a certain threshold amount of interactions with resources within the social network that are related to the resource accessed by the target member account.

The prompt module 325 is a hardware-implemented module which manages, controls, stores, and accesses information related to generating a prompt for display on a client device related to a target member account. The prompt includes a representation of a trusted member account(s). The prompt includes content based on the resource accessed by the target member account and/or a profile context attribute(s). The prompt includes a profile update functionality.

The profile update functionality module 330 is a hardware-implemented module which manages, controls, stores, and accesses information related to updating a profile of the target member account. The profile update functionality module 330 generates a profile update functionality to be included in a prompt. When the profile update functionality module 330 detects selection of the profile update functionality, a session of the target member account in the social network is initiated. The profile update functionality module 330 updates the profile of the target member account with one or more attributes based on at least one of the resource accessed by the target member account and/or a profile context attribute(s).

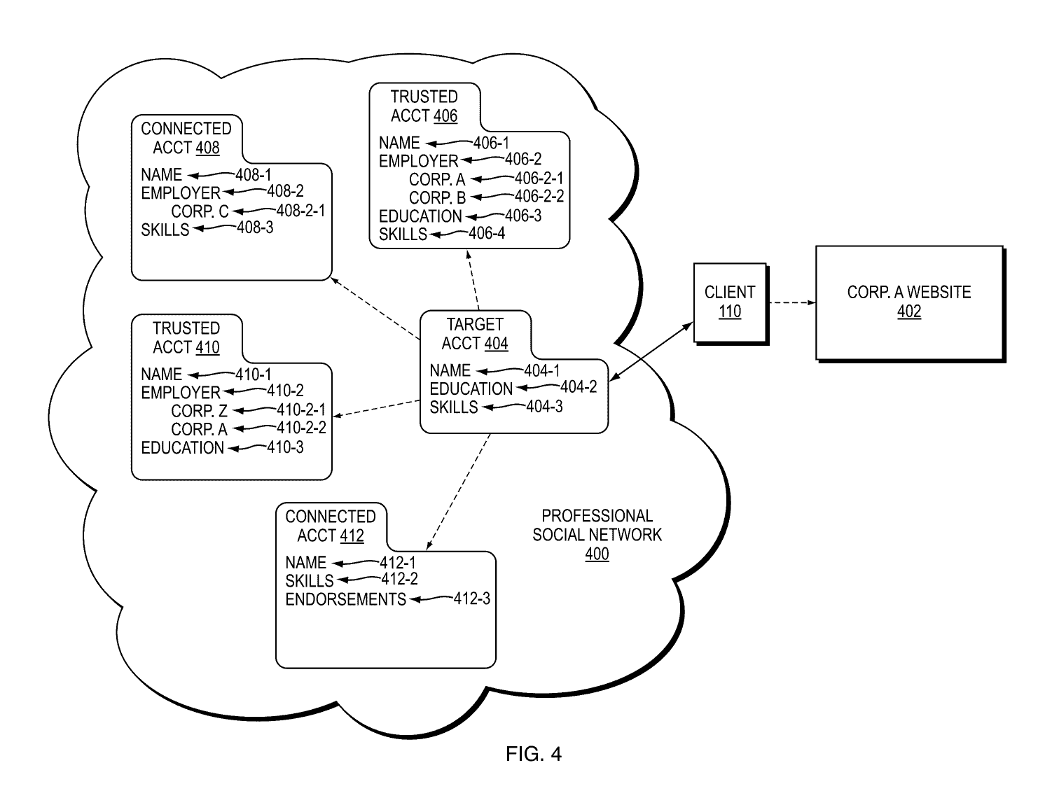

FIG. 4 is a block diagram showing an example of identifying trusted member accounts with respect to a client device accessing a resource external to a professional social network service, according to some embodiments.

A client device 110 corresponds with a target member account 404 in a professional social network 400. The target member account 404 include various profile attributes such as a name 404-1, educational background 404-2 (i.e. undergraduate and graduate education) and skills 404-3. The target member account 404 is connection to a plurality of account 406, 408, 410, 412 . . . in the professional social network 400. Account 406 has profile attributes, such as name 406-1, employment history 406-2 (current employer 406-2-1, former employer 406-2-2) educational background 406-3 and skills 406-4. Account 408 has profile attributes, such as name 408-1 employment history 408-2 (current employer 408-2-2) and skills 408-3. Account 410 has profile attributes, such as name 410-1, employment history 410-2 (current employer 410-2-1, former employer 410-2-2) educational background 410-3. Account 412 has profile attributes, such as name 412-1, skills 412-2 and endorsements 412-3 received from other accounts in the professional social network 400.

The client device 110 accesses a website 402, such as, for example, a website for Corporation A. The SP Engine 206 receives an indication that the client device 110 is accessing the website 402. Based on the detected access of the website 402, the SP Engine 206 searches databases in the data layer 205 to return a list of trusted member from the those accounts 406, 408, 410, 412 . . . having a predefined degree of connection with the target member account 404 in the professional social network 400. An employer database can be keyed according to Corporation A and the SP Engine 206 cross-references those member accounts listed in the employer database against the member account identifiers of the target member account's first degree connection in order to identify trusted accounts 406, 410.

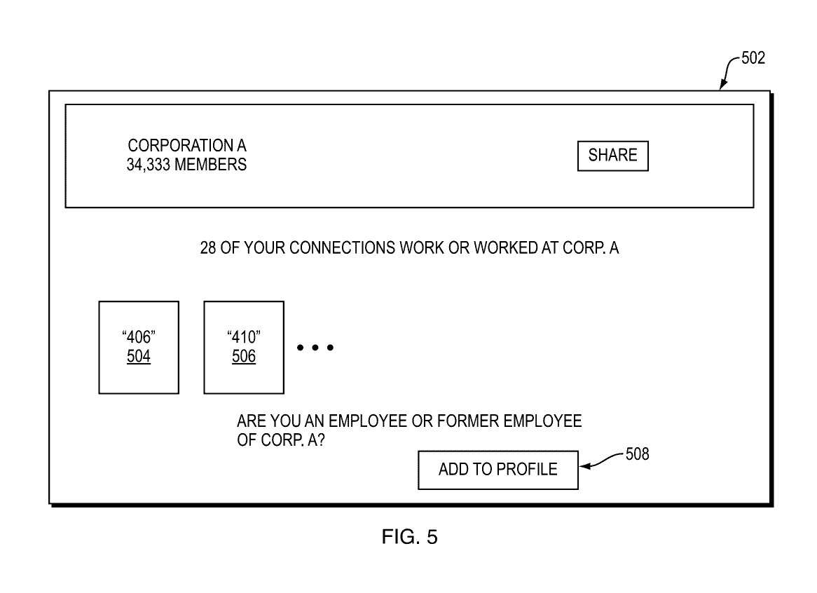

FIG. 5 is a block diagram showing an example prompt including a profile update functionality, according to some embodiments.

The SP Engine 206 generates a prompt 502 for display on the client device 110. In some embodiments, the prompt 502 is displayed on the client device 110 independent of an active session of the target member account 402 in the professional social network. In another embodiment, the prompt 502 is displayed by the SP Engine 206 concurrently with the display of the website 402 on the client device HO.

The SP Engine 206 generates content for the prompt 502 based on the profile attributes of the trusted accounts 406, 410 that matched with the content and/or metadata of the website 402. For example, since the SP Engine 206 identified a match based on the trusted account's 406 current employer attribute 406-2-1 and the trusted account's 410 former employer attribute 410-2-2, the SP Engine 206 generates content for the prompt 502, such as “28 of your connections work or worked at Corp. A,” The SP Engine 206 includes in the prompt 502 a representation 504, 506 of each of the one or more of the identified trusted accounts 406, 410 . . . .

In addition, SP Engine 206 similarly generates additional content for the prompt 502, such as “Are you an employee or former employee od Corp. A?” The SP Engine 206 includes a profile update functionality 508 in the prompt 502. The SP Engine 206 receives a selection of the profile update functionality 508. Based on the selection the SP Engine 206 initiates a session of the target member account 404 in the professional social network 400 and automatically updates the profile of the target member account 404. For example, the SP Engine 404 updates the profile of the target member account 404 with an employment history attribute and includes Corporation A in the profile of the target member account 404. The SP Engine 206 can request additional input from the target account member 404 to further specify if Corporation A is a current or former employer.

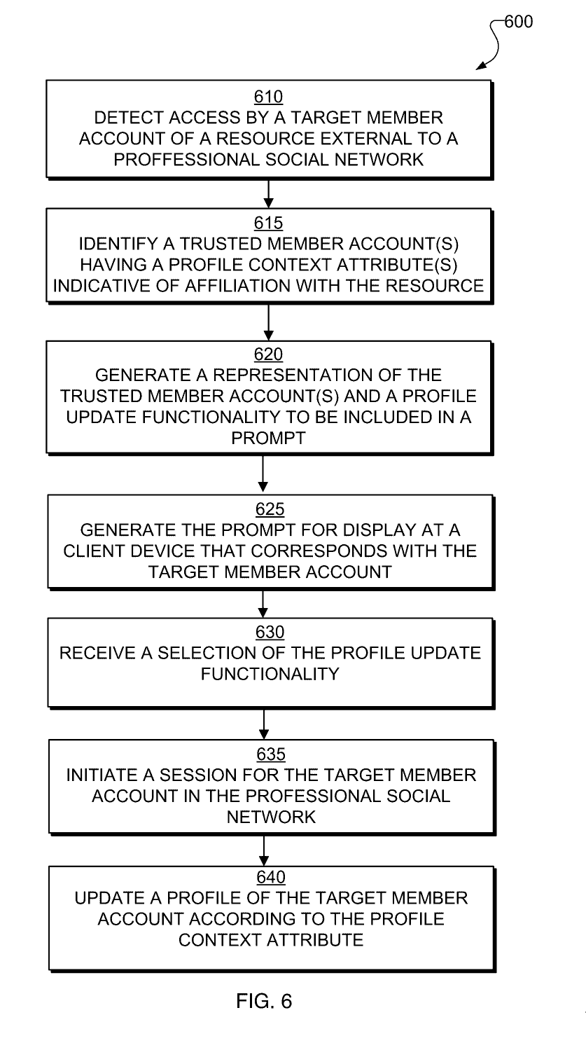

FIG. 6 is a flowchart illustrating a method 600 of sending a persistent message from a sender account to a target account, according to embodiments described herein.

At operation 610, the SP Engine 206 detects access by a target member account 404 of a resource 402 external to a professional social network 400. However, in other embodiments, the resource need not be external to the professional social network. For example, the resource can be a location or webpage within the professional social network 400.

At operation 615, the SP Engine 206 identifies a trusted member account(s) having a profile context attribute(s) that is indicative of a type of affiliation with the resource 402. It is noted that the affiliation with the resource describes 402 that the trusted member account has personal or professional history with an entity that is represented by the resource 402.

In some embodiments, the SP Engine 206 identifies a particular member account as a trusted member account even though no degree of connection exists between the target member account 404 and that particular member account. For example, where the target member account 404 accesses a web site for an educational institution, the SP Engine 206 accesses a school-based database in the data layer 205. The school-based database has a list of popular member account identifiers deemed most likely to be trusted for a respective educational institution. The determination of being a popular member account can be based on profile views, connection density and various other social network connections and metrics that are relevant (or indirectly related to) the respective educational institution.

The SP Engine 206 accesses the school-based database upon determining the target member account 404 doesn't have any first degree connections keyed to a particular educational institution. Since there are only a few thousand schools (<100 k), various embodiments of the SP Engine 206 can rely on caches of school-based queries in order to return a list of the most popular member accounts for a respective educational institution.

At operation 620, the SP Engine 206 generates a representation of the trusted member account(s) and a profile update functionality to be included in a prompt. In various embodiments, each representation 504, 506 of a trusted member account includes a profile photo of the trusted member account and a name of the trusted member account. The profile update functionality 508 includes a selectable icon functionality for triggering generation of content to update the target member account based on the profile context attribute.

At operation 625, the SP Engine 206 generates a prompt 502 for display at a client device 110 that corresponds with the target member account 404. In one embodiment, display of the prompt 502 can be overlayed upon a display of the resource at the client device 110. For example, upon the SP Engine 206 detecting the client device 110 is accessing and displaying a website 402, the SP Engine 206 generates the prompt 502 for display over a portion of the display of the website 402.

At operation 630, the SP Engine 206 receives a selection of the profile update functionality 508. For example, the SP Engine 206 detects input at the client device 110 representative of selection of the profile update functionality 508 while it is displayed as an overlay above the website 402.

At operation 635, the SP Engine 206 initiates a session for the target member account 404 in the professional social network 400.

At operation 640, the SP Engine 206 updates a profile of the target member account 404 in the professional social network 400 according to the profile context attribute. For example, the SP Engine 206 adds a profile section related to the profile context attribute to the target member account's 404 profile. The SP Engine 206 inserts the profile context attribute into the newly-added section in the target member account's 404 profile. In some embodiments, the SP Engine 206 can create an additional prompt(s) for the target member account 404 to edit the newly-added section. For example, if “Corporation A” was added to a newly-added “Employer” section in target member account's 404 profile, the SP Engine 206 further prompts the target member account 404 to verify dates of employment.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

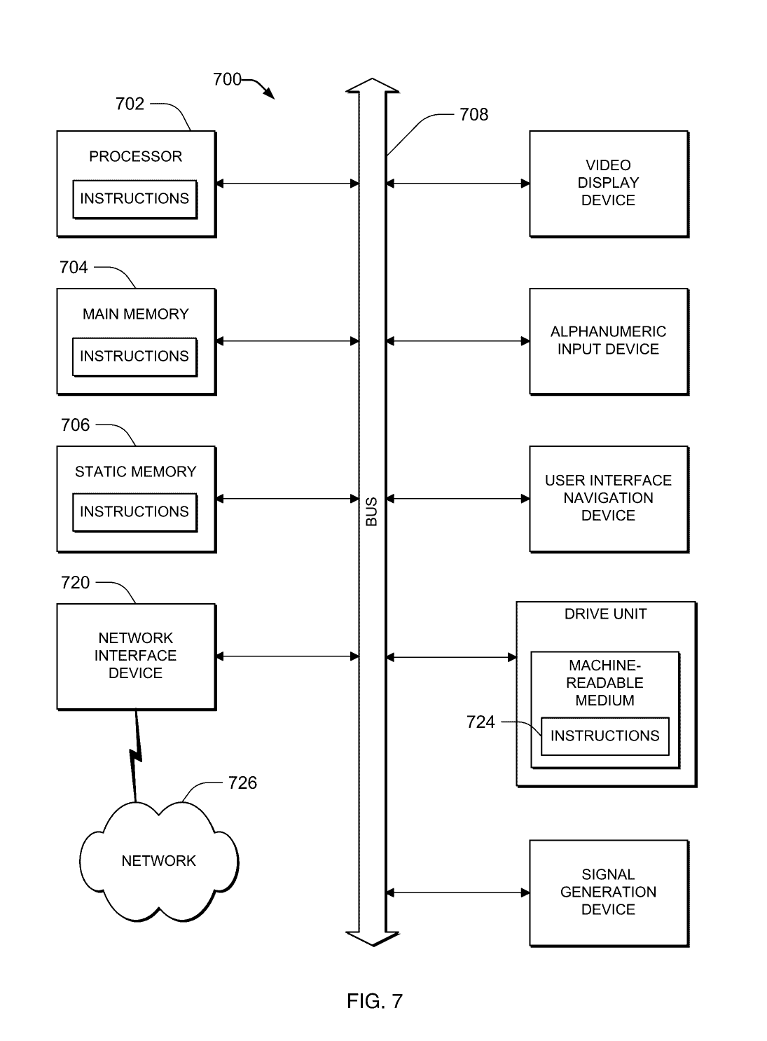

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (SIB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures e.g., software) 724 embodying or utilized by any one or more of the methodologies or functions described herein. Instructions 724 may also reside, completely or at least partially; within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory; including by way of example semiconductor memory devices, e.g., Erasable Programmable Read-Only Memory (EPROM); Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing; encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting access by a target member account of a resource;
identifying at least one trusted member account having a profile context attribute indicative of a type of affiliation with the resource; and
generating a prompt to update the target member account with the profile context attribute indicative of the type of affiliation with the resource.

2. The computer-implemented method of claim 1, wherein the target member account and each trusted member account are respective accounts in a social network; and
wherein each trusted member account has a predefined required degree of connection in the social network with the target member account in order to be trusted.

3. The computer-implemented method of claim 2, wherein detecting access by a target member account of a resource comprises:
detecting access, by a client device corresponding to the target member account, of a resource external to the social network.

4. The computer-implemented method of claim 3, wherein identifying at least one trusted member account having a profile context attribute indicative of a type of affiliation with the resource comprises:
including a representation of one or more of the trusted member accounts in the prompt; and
including in the prompt a profile update functionality based on the profile context attribute.

5. The computer-implemented method of claim 4, further comprising:
based on a selection of the profile update functionality:
(i) initiating a session in the social network for the target member account; and
(ii) generating profile update content based on the profile context attribute indicative of the type of affiliation with the resource; and
(iii) applying the profile update content to a profile of the target member account.

6. The computer-implemented method of claim 5, wherein identifying at least one trusted member account having a profile context attribute indicative of a type of affiliation with the resource comprises:
wherein the resource comprises a website of a company; and
determining a first trusted member account has a profile with a first profile context attribute indicative of employment at the company within a time range.

7. The computer-implemented method of claim 5, wherein identifying at least one trusted member account having a profile context attribute indicative of a type of affiliation with the resource comprises:
wherein the resource comprises a website of an educational institution; and
determining a first trusted member account has a profile with a first profile context attribute indicative of attendance at the education institution within a time range.

8. A non-transitory computer-readable medium storing executable instructions thereon,
which, when executed by a processor, cause the processor to perform operations including:
detecting access by a target member account of a resource;
identifying at least one trusted member account having a profile context attribute indicative of a type of affiliation with the resource; and
generating a prompt to update the target member account with the profile context attribute indicative of the type of affiliation with the resource.

9. The non-transitory computer-readable medium of claim 8, wherein the target member account and each trusted member account are respective accounts in a social network; and
wherein each trusted member account has a predefined required degree of connection in the social network with the target member account in order to be trusted.

10. The non-transitory computer-readable medium of claim 9, wherein detecting access by a target member account of a resource comprises:
detecting access; by a client device corresponding to the target member account, of a resource external to the social network.

11. The non-transitory computer-readable medium of claim 10, wherein identifying at least one trusted member account having a profile context attribute indicative of a type of affiliation with the resource comprises:
including a representation of one or more of the trusted member accounts in the prompt; and
including in the prompt a profile update functionality based on the profile context attribute.

12. The non-transitory computer-readable medium of claim 11, further comprising:
based on a selection of the profile update functionality:
(i) initiating a session in the social network for the target member account; and
(ii) generating profile update content based on the profile context attribute indicative of the type of affiliation with the resource; and
(iii) applying the profile update content to a profile of the target member account.

13. The non-transitory computer-readable medium of claim 12, wherein identifying at least one trusted member account having a profile context attribute indicative of a type of affiliation with the resource comprises:
wherein the resource comprises a website of a company; and
determining a first trusted member account has a profile with a first profile context attribute indicative of employment at the company within a time range.

14. The non-transitory computer-readable medium of claim 12, wherein identifying at least one trusted member account having a profile context attribute indicative of a type of affiliation with the resource comprises:
wherein the resource comprises a website of an educational institution; and
determining a first trusted member account has a profile with a first profile context attribute indicative of attendance at the education institution within a time range.

15. A computer system comprising:
a processor;
a memory device holding an instruction set executable on the processor to cause the computer system to perform operations comprising:
detecting access by a target member account of a resource;
identifying at least one trusted member account having a profile context attribute indicative of a type of affiliation with the resource; and
generating a prompt to update the target member account with the profile context attribute indicative of the type of affiliation with the resource.

16. The computer system of claim 15, wherein the target member account and each trusted member account are respective accounts in a social network; and
wherein each trusted member account has a predefined required degree of connection in the social network with the target member account in order to be trusted.

17. The computer system of claim 16, wherein detecting access by a target member account of a resource comprises:
detecting access, by a client device corresponding to the target member account, of a resource external to the social network.

18. The computer system of claim 17, wherein identifying at least one trusted member account having a profile context attribute indicative of a type of affiliation with the resource comprises:
including a representation of one or more of the trusted member accounts in the prompt; and
including in the prompt a profile update functionality based on the profile context attribute.

19. The computer system of claim 18, further comprising:
based on a selection of the profile update functionality:
(i) initiating a session in the social network for the target member account; and
(ii) generating profile update content based on the profile context attribute indicative of the type of affiliation with the resource; and
(iii) applying the profile update content to a profile of the target member account.

20. The computer system of claim 19, wherein identifying at least one trusted member account having a profile context attribute indicative of a type of affiliation with the resource comprises:
wherein the resource comprises a website of a company; and
determining a first trusted member account has a profile with a first profile context attribute indicative of employment at the company within a time range.
